(19) United States
(12) Patent Application Publication
(10) Pub. No.: US 2025/0236084 A1
(43) Pub. Date: Jul. 24, 2025

(54) ULTRAHIGH-SPEED BAR PRECISION SHEARING DEVICE ADOPTING TYPE OF ALTERNATING CURRENT SERVO MOTORS DRIVING FLYWHEEL TO SPIRALLY COMPRESS NITROGEN FOR ENERGY STORAGE

(71) Applicant: Xi’an Jiaotong University, Xi’an (CN)

(72) Inventors: Yujian REN, Xi’an (CN); Shengdun ZHAO, Xi’an (CN); Shanyi ZHANG, Xi’an (CN); Ming CHANG, Xi’an (CN); Wenyu ZHU, Xi’an (CN); Boyang LIU, Xi’an (CN)

(73) Assignee: Xi’an Jiaotong University, Xi’an (CN)

(21) Appl. No.: 18/948,927

(22) Filed: Nov. 15, 2024

(30) Foreign Application Priority Data
Jan. 23, 2024 (CN) 202410092614.0

(51) Int. Cl. B30B 1/18; B30B 1/23

(52) U.S. Cl. CPC B30B 1/188; B30B 1/23

(57) ABSTRACT

An ultrahigh-speed bar precision shearing device adopting a type of alternating current servo motors driving a flywheel to spirally compress nitrogen for energy storage includes a frame structure, a high-pressure air chamber mechanism, a hammer head movement mechanism and a mold are installed on the frame structure from top to bottom, the high-pressure air chamber mechanism cooperates with the hammer head movement mechanism to strike the mold, and bars are cut off and separated under the effect of the mold. The present application omits a complex hydraulic driving system, and ultrahigh-speed striking (20-30 m/s) of a hammer head is achieved in a manner of a flywheel spirally compressing nitrogen for energy storage; and control is simple, the return speed of the hammer head is high, and the energy utilization rate is high.

### CROSS-REFERENCE TO RELATED APPLICATIONS

This application claims priority to Chinese Patent Application No. 202410092614.0, filed on Jan. 23, 2024, which is hereby incorporated by reference in its entirety.

### TECHNICAL FIELD

The present application belongs to the technical field of high-speed shearing processing of metal bars, and particularly designs an ultrahigh-speed bar precision shearing device adopting a type of alternating current servo motors driving a flywheel to spirally compress nitrogen for energy storage.

### BACKGROUND

At present, a common high-speed bar precision shearing device is mainly a liquid-air hammer (Yuanzhe Dong. High-speed and Low-energy-consumption Combined Type Precision Shearing Separation Mechanism of Metal Bars and Dynamic Fracture Mechanical Behavior Research Thereof [D]. Xi'an: Xi'an Jiaotong University, 2020), and the structure principle is that a high-pressure air chamber is arranged on the upper portion of the device, and a piston and a movable shearing blade in the high-pressure air chamber are fixedly connected; a metal bar is placed below the movable shearing blade and clamped in a hydraulic clamping mold; and the working principle of the device is that high-pressure gas pushes a piston rod to move downwards, and the piston rod drives the shearing blade to shear the bar. This type of device has the following defects: firstly, a feeding piston is driven by a hydraulic pump station to compress gas for energy storage, so a hydraulic system is complex, the energy utilization rate is low, the price is high, and the control difficulty is high; and secondly, the speed of a hammer head is less than 10 m/s in the shearing process, the strain rate required by the ductile-brittle transition of the material cannot be achieved, and an active load required by shearing is large.

### SUMMARY

In order to overcome the defects of the above technology, the present application aims to provide an ultrahigh-speed bar precision shearing device adopting a type of alternating current servo motors driving a flywheel to spirally compress nitrogen for energy storage. A complex hydraulic driving system is omitted, and ultrahigh-speed striking (20-30 m/s) of a hammer head is achieved in a manner of a flywheel spirally compressing nitrogen for energy storage; and control is simple, the return speed of the hammer head is high, and the energy utilization rate is high.

In order to achieve the above objectives, the technical solution adopted by the present application is as follows.

An ultrahigh-speed bar precision shearing device adopting a type of alternating current servo motors driving a flywheel to spirally compress nitrogen for energy storage includes a frame structure, a high-pressure air chamber mechanism, a hammer head movement mechanism and a mold are installed on the frame structure from top to bottom, the high-pressure air chamber mechanism cooperates with the hammer head movement mechanism to strike the mold, and bars are cut off and separated under the effect of the mold.

The frame structure is formed by connecting an upper transverse beam a lower transverse beam and upright columns; tensioning screws are arranged inside the upright columns, upper transverse beam super nuts are arranged on an upper surface of the upper transverse beam, and the upper transverse beam super nuts are connected with upper ends of the tensioning screws; and lower transverse beam super nuts are symmetrically arranged on an inner side partition board of the lower transverse beam, and the lower transverse beam super nuts are connected with lower ends of the tensioning screws.

The high-pressure air chamber mechanism includes servo motors connected with two sides of the upper transverse beam, pinions installed on output shafts of the servo motors mesh with a flywheel, the flywheel is connected with a main screw, and the main screw is installed in an upper transverse beam middle cylinder through a supporting sleeve, a one-way thrust cylindrical roller bearing, a single-row cylindrical roller bearing and a screw lower baffle. The main screw is connected with a main nut, the main nut is fixedly connected with a nut sleeve through a hammer body connection end cover, the nut sleeve is connected with an upper surface of an upper sliding plate, a convex part of a lower surface of the upper sliding plate is matched with an inner ring of a main cylinder barrel, the main cylinder barrel is coaxially matched with a cylinder piston, the cylinder piston is coaxially matched with a cylinder copper sleeve, the cylinder copper sleeve is fixedly connected with the upper sliding plate through a cylinder tensioning screw, two sides of the upper sliding plate are fixedly connected with sliding blocks, the sliding blocks are in sliding fit with guide rails, and the guide rails are symmetrically installed on the upright columns at two sides.

The upper sliding plate, the cylinder barrel, the cylinder piston and the cylinder copper sleeve are connected through the cylinder tensioning screw to form a high-pressure air chamber, and the high-pressure air chamber is filled with nitrogen.

The hammer head movement mechanism includes first pulleys symmetrically installed on two sides of the upper sliding plate, the first pulleys are connected with second pulleys and third pulleys through belts, the second pulleys are symmetrically installed on two sides of a hammer head, the third pulleys are fixedly installed on the upright columns, locking apparatuses symmetrically installed on a front side and a rear side of the upright columns are connected with piston portions of hydraulic cylinders through locking apparatus supporting plates, the hydraulic cylinders are fixedly installed on a left side and a right side of the upright columns, and the hydraulic cylinders are connected with a hydraulic pump station through hydraulic valves and oil pipes.

Compared with the prior art, the present application has the following advantages.

Firstly, the alternating current permanent magnet servo synchronous motors drive the flywheel to spirally convert and compress nitrogen for energy storage, and the energy utilization rate is significantly higher than that of hydraulic transmission.

Secondly, the initial pressure intensity in the high-pressure air chamber before gas compression can reach 1-5 MPa, and the pressure intensity after energy storage can reach more than 10 MPa, so that huge energy can be stored; and after the energy is released, the hammer head can strike at a higher speed (20-30 m/s), so that the bars can be cut off and separated under the strain rate required by ductile-brittle transition, the active shearing load required to be provided by the device is reduced, and the fracture surface quality is improved.

### BRIEF DESCRIPTION OF THE DRAWINGS

FIG. 1 is a front view of the present application.

FIG. 2 is a left view of the present application and a schematic diagram of connection with a hydraulic pump station.

FIG. 3 is a top view of the present application.

### DETAILED DESCRIPTION OF THE EMBODIMENTS

The present application will be described in further detail with reference to the accompanying drawings.

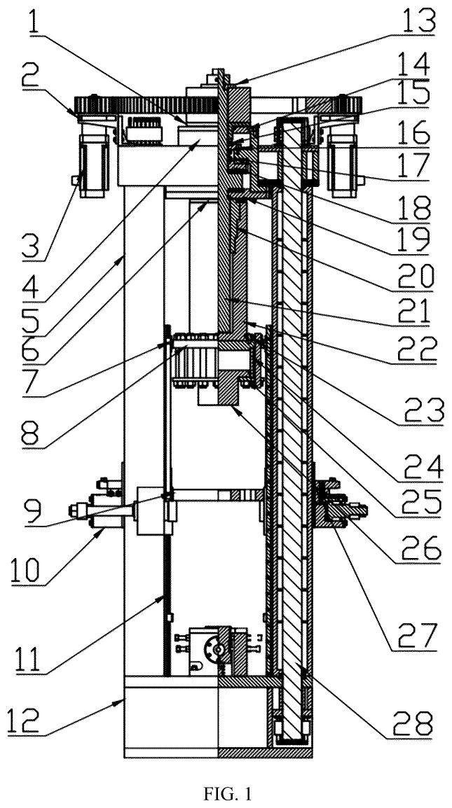

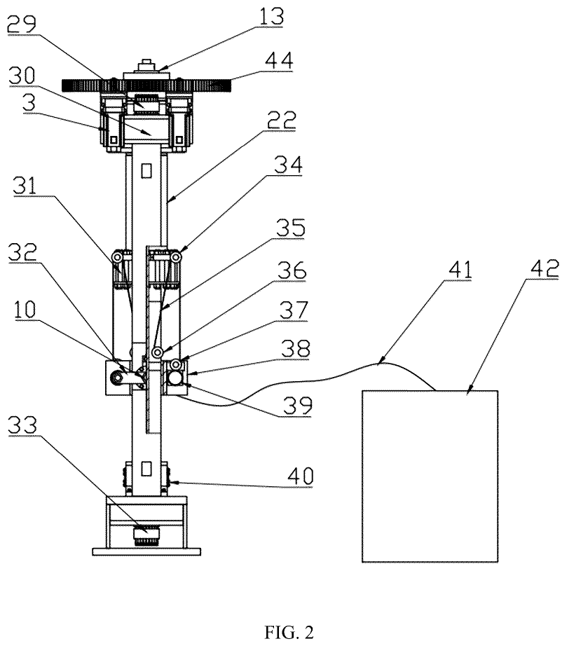

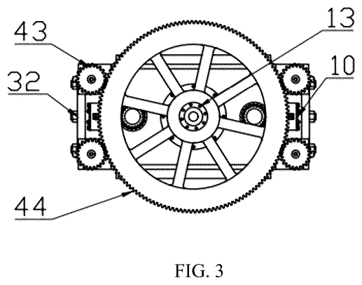

Referring to FIG. 1, FIG. 2 and FIG. 3, an ultrahigh-speed bar precision shearing device adopting a type of alternating current servo motors driving a flywheel to spirally compress nitrogen for energy storage includes a frame structure, a high-pressure air chamber mechanism, a hammer head movement mechanism and a mold 40 are installed on the frame structure from top to bottom, the high-pressure air chamber mechanism cooperates with the hammer head movement mechanism to strike the mold 40, and bars are cut off and separated under the effect of the mold 40.

The frame structure is formed by connecting an upper transverse beam 30, a lower transverse beam 12 and upright columns 5; tensioning screws 28 are arranged inside the upright columns 5, two groups of upper transverse beam super nuts 29 are arranged on an upper surface of the upper transverse beam 30, and the upper transverse beam super nuts 29 are connected with upper ends of the tensioning screws 28; and two groups of lower transverse beam super nuts 33 are symmetrically arranged on an inner side partition board of the lower transverse beam 12, and the lower transverse beam super nuts 33 are connected with lower ends of the tensioning screws 28.

The high-pressure air chamber mechanism includes four servo motors 3 fixedly connected with two sides of the upper transverse beam 30 through motor stands 2, pinions 43 installed on output shafts of the servo motors 3 mesh with a flywheel 44, the flywheel 44 is connected with a main screw 21 through an adjustment flange 13, and the main screw 21 is installed in an upper transverse beam middle cylinder 4 through a supporting sleeve 1, a transverse beam upper end cover 14, a one-way thrust cylindrical roller bearing 15, a thrust bearing upper end cover 16, a single-row cylindrical roller bearing 17, a thrust bearing seat 18 and a screw lower baffle 19. The main screw 21 is connected with a main nut 20, the main nut 20 is fixedly connected with a nut sleeve 22 through a hammer body connection end cover 6, the nut sleeve 22 is connected with an upper surface of an upper sliding plate 8 through a flange plate 23, a convex part of a lower surface of the upper sliding plate 8 is matched with an inner ring of a main cylinder barrel 24, the main cylinder barrel 24 is coaxially matched with a cylinder piston 26, the cylinder piston 26 is coaxially matched with a cylinder copper sleeve 25, the cylinder copper sleeve 25 is fixedly connected with the upper sliding plate 8 through a cylinder tensioning screw 31, two sides of the upper sliding plate 8 are fixedly connected with sliding blocks 7, the sliding blocks 7 are in sliding fit with guide rails 11, and the guide rails 11 are symmetrically installed on the upright columns 5 at two sides.

The upper sliding plate 8, the cylinder barrel 24, the cylinder piston 26 and the cylinder copper sleeve 25 are connected through the cylinder tensioning screw 31 to form a high-pressure air chamber, and the high-pressure air chamber is filled with nitrogen.

The hammer head movement mechanism includes four first pulleys 34 symmetrically installed on two sides of the upper sliding plate 8, the first pulleys 34 are connected with second pulleys 37 and third pulleys 36 through belts 35, the second pulleys 37 are symmetrically installed on two sides of a hammer head 9, the third pulleys 36 are fixedly installed on the upright columns 5, four locking apparatus supporting bases 38 are symmetrically installed on a front side and a rear side of the upright columns 5, the locking apparatus supporting bases 38 are coaxially matched with locking apparatus supporting plates 32, locking apparatuses 39 connected with the locking apparatus supporting bases 38 are connected with piston portions of hydraulic cylinders 10 through the locking apparatus supporting plates 32, the hydraulic cylinders 10 are fixedly installed on a left side and a right side of the upright columns 5, and the hydraulic cylinders 10 are connected with a hydraulic pump station 42 through hydraulic valves 27 and oil pipes 41.

The working principle of the present application is as follows.

The present application utilizes the characteristic that the toughness of a metal material is reduced and the brittleness is increased at a high strain rate, the four servo motors 3 drive the pinion 43 to drive the flywheel 44 to rotate, and the flywheel 44 drives the main screw 21 to rotate; the main screw 21 is limited by the screw lower baffle 19 and cannot move up and down; the main nut 20 moves downwards under the rotary meshing drive of the main screw 21; the nut sleeve 22 is fixedly connected with the main nut 20 and moves downwards along with the main nut 20; the high-pressure air chamber formed by connecting the upper sliding plate 8, the cylinder barrel 24, the cylinder piston 26 and the cylinder copper sleeve 25 through the cylinder tensioning screw 31 is filled with nitrogen, the high-pressure air chamber moves downwards along with the nut sleeve 22, and when the cylinder piston 26 makes contact with the hammer head 9, the hammer head 9 cannot move downwards due to the limiting effect of the locking apparatus supporting plates 32; and the cylinder piston 26 is blocked and moves upwards relative to the cylinder barrel 24, the nitrogen in the high-pressure air chamber is compressed, and the internal pressure rises sharply. When the pressure in the high-pressure air chamber reaches a designed critical value, hydraulic oil enters the hydraulic cylinders 10 from the pump station 42 along the oil pipes 41 by controlling the hydraulic valves 27; the pistons of the hydraulic cylinders 10 drive the locking apparatus supporting plates 32 and the locking apparatuses 39 to move towards the outer side of the upright columns 5; the locking apparatus supporting plates 32 are pulled away, the hammer head 9 is pushed by the cylinder piston 26 to move towards the shearing mold 40 at a high speed, at the moment, the pressure energy in the high-pressure air chamber is converted into the kinetic energy of the hammer head 9, and under the combined action of gravity, the speed of the hammer head 9 reaches 20-30 m/s; and the hammer head 9 strikes a movable shearing block of the mold 40, and the bars are cut off and separated under the action of the movable shearing block.

The first pulleys 34, the belts 35, the second pulleys 37 and the third pulleys 36 constitute a movable pulley pair, and in the falling process of the hammer head 9, the belts 35 move downwards under driving of the second pulleys 37 fixedly connected with the hammer head 9. According to the characteristic of the movable pulley pair, the belts 35 in this process are in a loose state all the time, and it is guaranteed that the hammer head 9 can freely fall.

In the return process, the four servo motors 3 drive the pinion 43 to rotate reversely and drive the flywheel 44 to rotate reversely; the main screw 21 is driven by the flywheel 44 to rotate reversely, and the main nut 20, the nut sleeve 22 and the high-pressure air chamber partially move upwards; the first pulleys 34 fixedly connected with the upper sliding plate 8 move upwards, and the third pulleys 36 do not move, so that the second pulleys 37 and the hammer head 9 are driven to move upwards; the hammer head 9 leaves the upper surface of the shearing mold 40 and returns to the initial position before striking, at the moment, the four servo motors 3 stop rotating, and the hammer head 9 stops moving; and the hydraulic valves 27 are reversed, the pistons of the hydraulic cylinders 10 drive the locking apparatus supporting plates 32, the locking apparatus supporting plates 39 move towards the inner side of the upright columns 5, and the locking apparatus supporting plates 39 moves to the position right below the hammer head 9 to support the hammer head 9.

What is claimed is:

1. An ultrahigh-speed bar precision shearing device, adopting a type of alternating current servo motors driving flywheels to spirally compress nitrogen for energy storage, comprising a frame structure,
wherein a high-pressure air chamber mechanism, a hammer head movement mechanism and a mold are installed on the frame structure from top to bottom, the high-pressure air chamber mechanism cooperates with the hammer head movement mechanism to strike the mold, and bars are cut off and separated under effect of the mold.

2. The device according to claim 1, wherein the frame structure is formed by connecting an upper transverse beam, a lower transverse beam and upright columns;
tensioning screws are arranged inside the upright columns, upper transverse beam super nuts are arranged on an upper surface of the upper transverse beam, and the upper transverse beam super nuts are connected with upper ends of the tensioning screws; and
lower transverse beam super nuts are symmetrically arranged on an inner side partition board of the lower transverse beam, and the lower transverse beam super nuts are connected with lower ends of the tensioning screws.

3. The device according to claim 2, wherein the high-pressure air chamber mechanism comprises servo motors connected with two sides of the upper transverse beam, pinions installed on output shafts of the servo motors mesh with a flywheel, the flywheel is connected with a main screw, and the main screw is installed in an upper transverse beam middle cylinder through a supporting sleeve, a one-way thrust cylindrical roller bearing, a single-row cylindrical roller bearing and a screw lower baffle;
the main screw is connected with a main nut, the main nut is fixedly connected with a nut sleeve through a hammer body connection end cover, the nut sleeve is connected with an upper surface of an upper sliding plate, a convex part of a lower surface of the upper sliding plate is matched with an inner ring of a main cylinder barrel, the main cylinder barrel is coaxially matched with a cylinder piston, the cylinder piston is coaxially matched with a cylinder copper sleeve, the cylinder copper sleeve is fixedly connected with the upper sliding plate through a cylinder tensioning screw, two sides of the upper sliding plate are fixedly connected with sliding blocks, the sliding blocks are in sliding fit with guide rails, and the guide rails are symmetrically installed on the upright columns at two sides; and
the upper sliding plate, the cylinder barrel, the cylinder piston and the cylinder copper sleeve are connected through the cylinder tensioning screw to form a high-pressure air chamber.

4. The device according to claim 3, wherein the hammer head movement mechanism comprises first pulleys symmetrically installed on two sides of the upper sliding plate, the first pulleys are connected with second pulleys and third pulleys through belts, the second pulleys are symmetrically installed on two sides of a hammer head, the third pulleys are fixedly installed on the upright columns, locking apparatuses symmetrically installed on a front side and a rear side of the upright columns are connected with piston portions of hydraulic cylinders through locking apparatus supporting plates, the hydraulic cylinders are fixedly installed on a left side and a right side of the upright columns, and the hydraulic cylinders are connected with a hydraulic pump station through hydraulic valves and oil pipes.
